(19) United States
(12) Patent Application Publication
(10) Pub. No.: US 2016/0156526 A1
(43) Pub. Date: Jun. 2, 2016

(54) SERVER FOR SELECTIVELY SWITCHING MANAGEMENT NETWORK

(71) Applicants: Inventec (Pudong) Technology Corporation, Shanghai (CN); Inventec Corporation, Taipei City (TW)

(72) Inventor: Ying-Xian HAN, Shanghai (CN)

(21) Appl. No.: 14/596,033

(22) Filed: Jan. 13, 2015

(30) Foreign Application Priority Data
Nov. 27, 2014 (CN) 201410707263.6

(51) Int. Cl. H04L 12/24

(52) U.S. Cl. CPC H04L 41/24

(57) ABSTRACT

A server for selectively switching management network is disclosed in the present invention. In the server, a baseboard management controller (BMC) is provided to send a connection signal in a dedicated management network connection status. The BMC is also provided to send a trigger signal and the connection signal in a triggering event. A dedicated network connection controller of a dedicated network connection module receives the connection signal in the dedicated management network connection status to make the BMC connect to a client through a dedicated network connection port of the dedicated network connection module. In the triggering event, a programmable logic unit receives the connection signal to transmit a switch signal to a switch of a general network connection module. When the switch receives the switch signal, the switch is turned on to make a general network connection controller of the general network connection module receive the connection signal. When the general network connection controller receives the connection signal, the BMC is connected to the client through a general network connection port.

### FIELD OF THE INVENTION

The present invention is related to a server for selectively switching management network, and more particularly related to the server for selectively switching management network, which switches from a dedicated network connection module to a general network connection module when encountering a triggering event.

### BACKGROUND OF THE INVENTION

Attending with progress of technology, the development of network has led to a life full of electronic devices, and the server is a fundamental apparatus for establishing a network. In present, the servers usually have a Dedicated NIC (network interface card) which includes a controller and a connecting port. The system information, such as version of firmware, sensed temperature, and etc., can be checked from the client through the above mentioned NIC. However, as the circuitry of NIC is damaged, such information cannot be checked anymore for further debugging or analyzing, and thus, there exists the need to improve the technology in present.

### BRIEF SUMMARY OF INVENTION

The servers nowadays have the problem that the client cannot manage the system information as the dedicated NIC is damaged. Accordingly, the present invention provides a server for selectively switching management network, which switches from the dedicated network connection module to the general network connection module when encountering a triggering event, to resolve the above mentioned problem.

Based on the above mentioned object, a server for selectively switching management network is provided in accordance with an embodiment of the present invention. The server comprises a baseboard management controller, a dedicated network connection module, a programmable logic unit and at least a general network connection module. The baseboard management controller is utilized for sending a connection signal under a dedicated management network connection status and sending a trigger signal and the connection signal when encountering a triggering event. The dedicated network connection module comprises a dedicated network connection port and a dedicated network connection controller. The dedicated network connection controller is electrically connected to the baseboard management controller and the dedicated network connection port for receiving the connection signal under the dedicated management network connection status and communicated with a client through the dedicated network connection port. The programmable logic unit is electrically connected to the baseboard management controller for receiving the trigger signal when encountering the triggering event so as to generate and transmit a switch signal. The general network connection module comprises a general switch, a general network connection port, and a general network connection controller. The general switch is electrically connected to the programmable logic unit. The general switch is triggered to be turned on when receiving the switch signal. The general network connection controller is electrically connected to the general switch and the general network connection port for receiving the connection signal after the general switch is turned on and communicated with the client through the general network connection port.

In accordance with an embodiment of the server for selectively switching management network provided in the present invention, the dedicated network connection controller is an Ethernet physical layer (PHY) chip, the dedicated network connection port and the general network connection port are RJ45 ports, the programmable logic unit is a complex programmable logic device (CPLD), the general network connection controller is a network controller with sideband interface (NCSI), the connection signal is a reduced media independent interface (RMII) signal, and the switch signal is an active-low signal. In addition, the dedicated network connection module further comprises a dedicated switch, which is electrically connected to the dedicated network connection controller and the programmable logic unit, the programmable logic unit transmits the switch signal to the dedicated switch and the general switch when encountering the triggering event so as to turn off the dedicated switch and turn on the general switch.

By using the server for selectively switching management network provided in accordance with the present invention, which is capable to switch from the dedicated network connection module to the general network connection module when encountering a triggering event such that the system information can be managed to resolve the problem of the conventional art.

The embodiments adopted in the present invention would be further discussed by using the flowing paragraph and the figures for a better understanding.

### BRIEF DESCRIPTION OF THE DRAWINGS

FIG. 1 is a first block diagram showing the server for selectively switching management network in accordance with a first preferred embodiment of the present invention;

FIG. 2 is a second block diagram showing the server for selectively switching management network in accordance with the first preferred embodiment of the present invention; and

FIG. 3 is a block diagram showing the server for selectively switching management network in accordance with a second preferred embodiment of the present invention.

### DETAILED DESCRIPTION OF THE INVENTION

There are various embodiments of the server for selectively switching management network provided in accordance with the present invention, which are not repeated hereby. Only a preferred embodiment is mentioned in the following paragraph as an example.

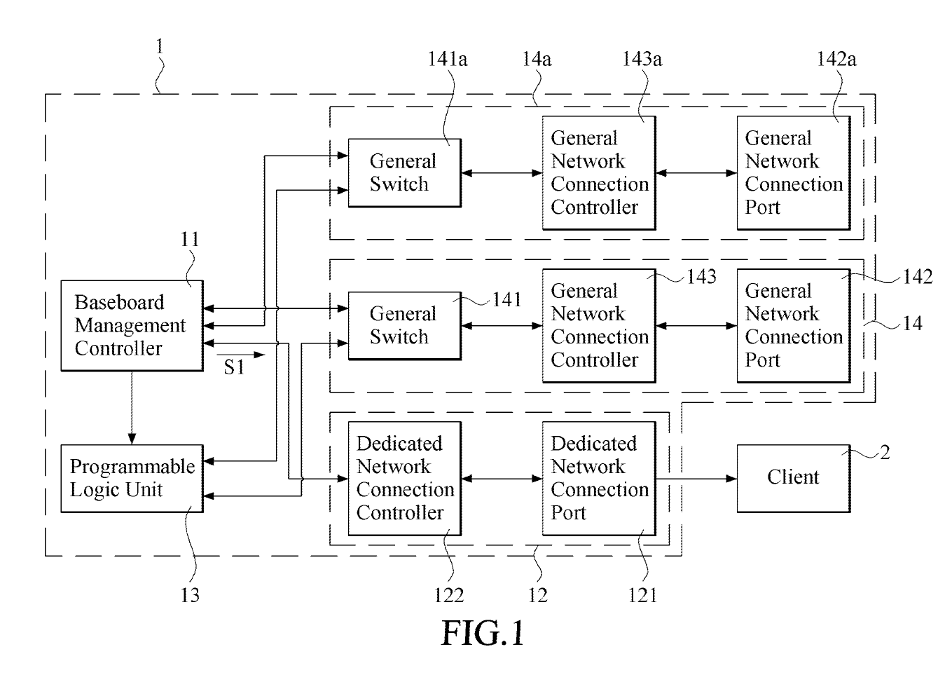

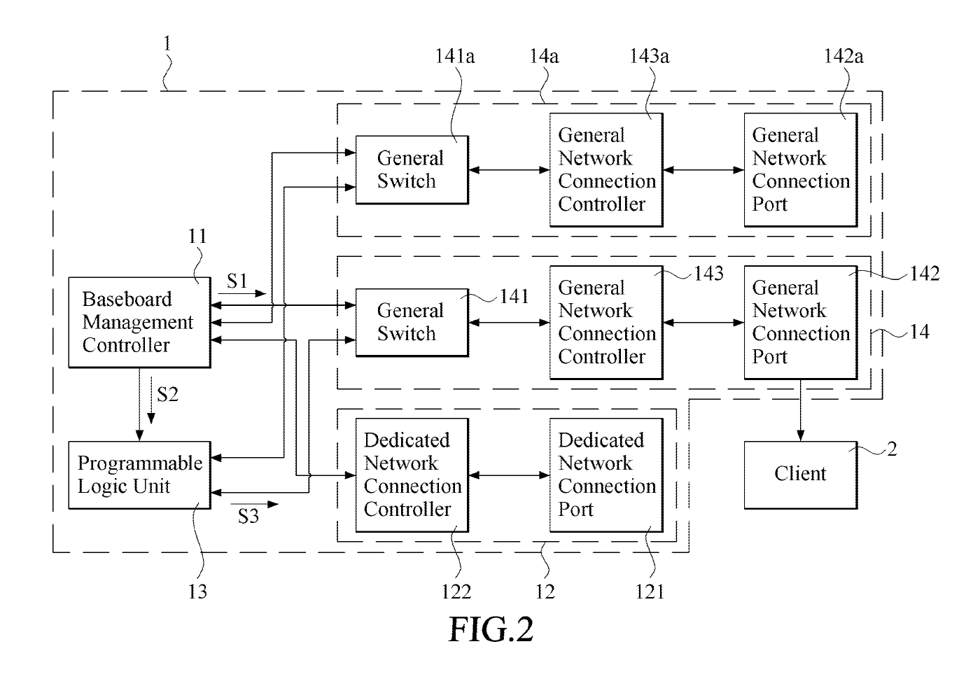

Please refer to FIG. 1 and FIG. 2, wherein is a first block diagram showing the server for selectively switching management network in accordance with a first preferred embodiment of the present invention and FIG. 2 is a second block diagram showing the server for selectively switching management network in accordance with the first preferred embodiment of the present invention. As shown, the server 1 for selectively switching management network provided in accordance with the preferred embodiment of the present invention includes a baseboard management controller (BMC) 11, a dedicated network connection module 12, a programmable logic unit 13, and at least one general network connection module 14, 14a.

The dedicated network connection module 12 includes a dedicated network connection port 121 and a dedicated network connection controller 122. The dedicated network connection port 121 is a RJ45 port. The dedicated network connection controller 122 is electrically connected to the baseboard management controller 11 and the dedicated network connection port 121, and the dedicated network connection controller 122 is an Ethernet physical layer (PHY) chip. However, the present invention is not so restricted.

The programmable logic unit 13 is electrically connected to the baseboard management controller 11, and the programmable logic unit 13 can be a complex programmable logic device (CPLD).

The general network connection modules 14 and 14a include general switches 141, 141a, general network connection ports 142, 142a, and general network connection controllers 143, 143a, respectively. The general switches 141, 141a are electrically connected to the programmable logic unit 13. The general switches 141, 141a may be electrically connected to the baseboard management controller 11 directly in the other embodiments of the present invention. The general network connection ports 142, 142a are RJ 45 ports. The general network connection controllers 143, 143a are respectively electrically connected to the general switches 141, 141a, and general network connection ports 142, 142a. The general network connection controller 143 is a network controller with sideband interface (NCSI), and the general network connection controller 143a is a network controller with reduce media independent interface (RMII), such as ALOM RMII. In accordance with the other embodiments, the network controllers with the function of MII, GMII, SGMII, or XGMII can also be used in the present invention.

Under the normal state, the baseboard management controller 11 is utilized for sending a connection signal S1 under a dedicated management network connection status. The connection signal is a RMII signal and the dedicated management network connection status is the status in which the manager wants to check the system information such as the version of firmware and the sensed temperature. The dedicated network connection controller 122 is utilized for receiving the connection signal S1 under the dedicated management network connection status, and is communicated with a client 2 (which can be regarded as the electronic devices of the client) through the dedicated network connection port 121 such that the client 2 can check the system information by using the dedicated network connection module 12.

As the dedicated network connection module 12 is damaged or a triggering event (in the present embodiment, as shown in FIG. 2, the dedicated network connection module 12 is damaged) appointed by the manager is encountered, the baseboard management controller 11 sends a trigger signal S2. The programmable logic unit 13 receives the trigger signal S2 so as to generate and transmit a switch signal S3. The switch signal S3 is a low active signal. The general switch 141 is triggered to be turned on (or conducted) after receiving the switch signal S3. In accordance with the other embodiment, the general switch 141a may be triggered to be turned on. At this time, the connection signal S1 generated by the baseboard management controller 11 can be transmitted through the general switch 141 to the general network connection controller 143 to have the baseboard management controller 11 communicate with the client 2 through the general network connection port 142 as shown in FIG. 2 such that the client 2 can manage the above mentioned system information through the general network connection module 14.

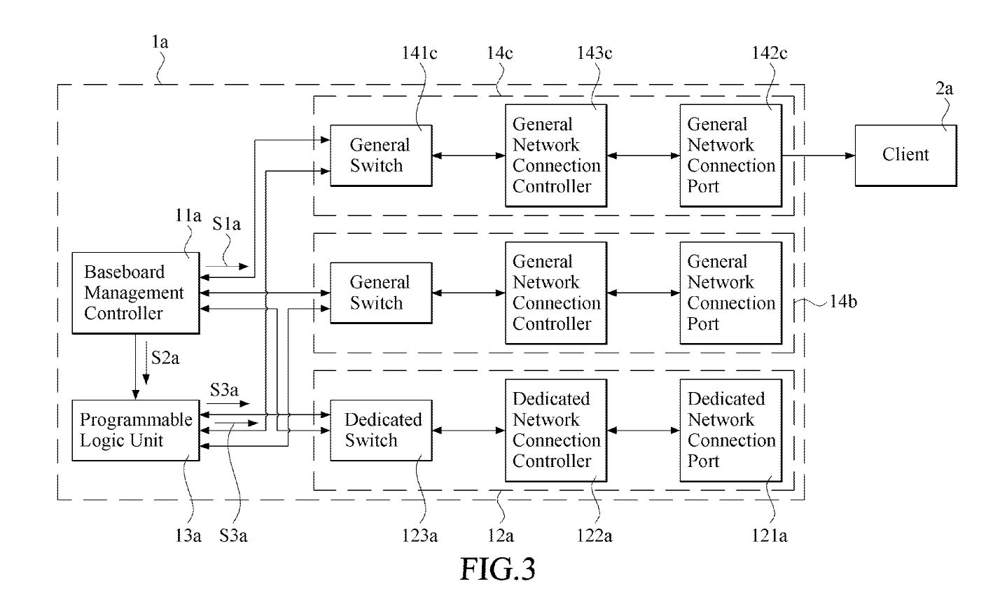

Please refer to FIG. 3, which is a block diagram showing the server for selectively switching management network in accordance with a second preferred embodiment of the present invention. As shown, the server al for selectively switching management network includes a baseboard management controller 11a, a dedicated network connection module 12a, a programmable logic unit 13a and at least one general network connection module 14b, 14c, which are corresponding to the general network connection modules 14 and 14a of the first preferred embodiment respectively.

The difference between the second preferred embodiment and the first preferred embodiment is that the dedicated network connection module 12a of the second preferred embodiment includes a dedicated switch 123a in addition to a dedicated network connection port 121a and a dedicated network connection controller 122a. The dedicated switch 123a is electrically connected to the dedicated network connection controller 122a and the programmable logic unit 13a.

In the second preferred embodiment, as the manager appoints a triggering event of the general network connection module 14c through an input interface such as the system software, the mouse, the keyboard, and etc., the baseboard management controller 11a sends a trigger signal S2a, and the programmable logic unit 13a transmits the switch signal S3a to the dedicated switch 123a and the general switch 141c to turn off the dedicated switch 123a but turn on the general switch 141c so as to have the connection signal S1a transmitted to the general network connection controller 143c through the general switch 141c. As a preferred embodiment, the connection signal S1a can further be used to trigger and start the general network connection port 142c. Then the baseboard management controller 11 a can communicate with the client 2a through the general network connection port 142c such that the client 2a can manage the above mentioned system information by using the general network connection module 14c.

In conclusion, when adopting the server for selectively switching management network provided in the present invention, because the client can communicate with the baseboard management controller as the network connection is switched to the general network connection module when encountering the triggering event, thus, the system information can still be managed and the problem of the conventional art can be effectively resolved.

The detail description of the aforementioned preferred embodiments is for clarifying the feature and the spirit of the present invention. The present invention should not be limited by any of the exemplary embodiments described herein, but should be defined only in accordance with the following claims and their equivalents. Specifically, those skilled in the art should appreciate that they can readily use the disclosed conception and specific embodiments as a basis for designing or modifying other structures for carrying out the same purposes of the present invention without departing from the scope of the invention as defined by the appended claims.

We claim:

1. A server for selectively switching management network, comprising:
a baseboard management controller, utilized for sending a connection signal under a dedicated management network connection status, and sending a trigger signal and the connection signal when encountering a triggering event;
a dedicated network connection module, comprising:
a dedicated network connection port; and
a dedicated network connection controller, electrically connected to the baseboard management controller and the dedicated network connection port, for receiving the connection signal under the dedicated management network connection status and communicated with a client through the dedicated network connection port;
a programmable logic unit, electrically connected to the baseboard management controller, for receiving the trigger signal when encountering the triggering event so as to generate and transmit a switch signal; and
at least a general network connection module, comprising:
a general switch, electrically connected to the programmable logic unit, and being turned on when receiving the switch signal;
a general network connection port; and
a general network connection controller, electrically connected to the general switch and the general network connection port, receiving the connection signal after the general switch is turned on, and communicated with the client through the general network connection port.

2. The server for selectively switching management network of claim 1, wherein the dedicated network connection controller is an Ethernet physical layer (PHY) chip.

3. The server for selectively switching management network of claim 1, wherein the dedicated network connection port or the general network connection port is RJ45 ports.

4. The server for selectively switching management network of claim 1, wherein the programmable logic unit is a complex programmable logic device (CPLD).

5. The server for selectively switching management network of claim 1, wherein the general network connection controller is a network controller with sideband interface (NCSI).

6. The server for selectively switching management network of claim 1, wherein the connection signal is a reduced media independent interface (RMII) signal.

7. The server for selectively switching management network of claim 1, wherein the switch signal is an active-low signal.

8. The server for selectively switching management network of claim 1, wherein the dedicated network connection module further comprises a dedicated switch, which is electrically connected to the dedicated network connection controller and the programmable logic unit, the programmable logic unit transmits the switch signal to the dedicated switch and the general switch when encountering the triggering event so as to turn off the dedicated switch and turn on the general switch.
